(19) United States
(12) Patent Application Publication
(10) Pub. No.: US 2024/0210300 A1
(43) Pub. Date: Jun. 27, 2024

(54) Flow Cytometry System and Methods for Use

(71) Applicant: Sartorius BioAnalytical Instruments, Inc., Bohemia, NY (US)

(72) Inventors: Zhaoping Liu, Rio Rancho, NM (US); Joseph Carter, Los Gatos, CA (US); Jerry Hurst, Boulder Creek, CA (US); David Pedersen, Portland, OR (US); Cliff Elion, Westlake Village, CA (US); Richard Bennett, Albuquerque, NM (US)

(21) Appl. No.: 18/146,560

(22) Filed: Dec. 27, 2022

(51) Int. Cl. G01N 15/14

(52) U.S. Cl. CPC G01N 15/1404; G01N 15/1436; G01N 2015/1006

(57) ABSTRACT

The present disclosure provides flow cytometry system. The flow cytometry system includes a flow cell, a fluidic pathway in fluid communication with the flow cell, and a probe in fluid communication with the fluidic pathway. The probe is configured to input a plurality of samples and aliquots of a separation gas between successive ones of the plurality of samples into the fluidic pathway. The flow cytometry system also includes two or more lasers positioned such that an illumination spot of each of the two or more lasers is directly on the flow cell, and two or more side scatter detection modules in communication with the two or more lasers. The flow cytometry system also includes a processor in communication with the two or more side scatter detection modules, and a non-transitory computer readable medium having stored therein instructions that are executable to cause the processor to perform functions when using the flow cytometer system. The functions include determining a time delta between a first laser of the two or more lasers and a second laser of the two or more lasers based on a difference between a plurality of first timestamps detected by a first side scatter detection module and a plurality of second timestamps detected by a second side scatter detection module.

### BACKGROUND

Flow cytometry is a technology employed in cell counting, cell sorting, biomarker detection and protein engineering, for example, conducted by suspending cells in a stream of fluid and passing them by an electronic detection apparatus. Flow cytometry allows simultaneous multiparametric analysis of the physical and/or chemical characteristics of up to tens of thousands of particles per second. Traditionally, flow cytometers are standalone instruments designed to measure biological samples which are in aqueous suspensions contained in assay plates or vials, and may be capable of actively separating and isolating particles that have properties of interest. As such, they are typically independent lab instruments. An operator (or robotic device) presents the sample(s) to the cytometer, the cytometer performs its measurements, and the cytometer reports the results to the operator. Traditionally, flow cytometry has been used for low throughput sample analysis by placing samples, one-by-one, under the sampling port of the cytometer.

More recently, high-throughput flow cytometry systems have been developed to quickly deliver samples at microliter volumes to the flow cytometry engine. High-throughput flow cytometry systems use a pump system to fill a sample tubing line with a stream of discrete sample particle suspensions aspirated from wells of a microplate and separated one from the other by air bubble gaps. The entire sample stream is continuously delivered to the flow cytometer so that data from all the samples in the microplate are acquired and stored in a single data file. A high-resolution time parameter is also recorded during data acquisition. Temporal gaps in particle detection are created in the data stream by the passage of the air gaps, allowing the individual particle suspensions to be distinguished and separately evaluated when plotted in conjunction with the time parameter. Based on this temporal distribution, data peaks are identified and assigned to individual wells of the microplate. The present disclosure provides various improvements for high-throughput flow cytometry systems.

### SUMMARY

In a first aspect, the present disclosure provides flow cytometry system comprising: (a) a flow cell, (b) a fluidic pathway in fluid communication with the flow cell, (c) a probe in fluid communication with the fluidic pathway, wherein the probe is configured to input a plurality of samples and aliquots of a separation gas between successive ones of the plurality of samples into the fluidic pathway. (d) two or more lasers positioned such that an illumination spot of each of the two or more lasers is directly on the flow cell, (e) two or more side scatter detection modules in communication with the two or more lasers. (f) a processor in communication with the two or more side scatter detection modules, and (g) a non-transitory computer readable medium having stored therein instructions that are executable to cause the processor to perform functions when using the flow cytometer system, including: (i) detecting, via a first side scatter detection module of the two or more side scatter detection modules, a first sample of the plurality of samples in the fluidic pathway at a first timestamp, (ii) detecting, via a second side scatter detection module of the two or more side scatter detection modules, the first sample of the plurality of samples in the fluidic pathway at a second timestamp after the first timestamp, and (iii) determining a time delta between a first laser of the two or more lasers and a second laser of the two or more lasers based on a difference between a plurality of first timestamps and a plurality of second timestamps.

In a second aspect, the present disclosure provides a flow cytometry system comprising: (a) a flow cell, (b) a fluidic pathway in fluid communication with the flow cell, (c) a probe having a first end and a second end opposite the first end, wherein the second end of the probe is in fluid communication with the fluidic pathway, and (d) a collar wash module positioned adjacent the probe, wherein the collar wash module includes a top opening, a bottom opening in fluid communication with the top opening via a common shaft, a first side opening, and a second side opening in fluid communication with the first side opening via the common shaft, wherein the probe is configured to transition from a first position in which the first end of the probe is positioned outside of the collar wash module to a second position in which the first end of the probe is positioned inside of the collar wash module between the first side opening and the second side opening to a third position in which the first end of the probe is positioned outside of the collar wash module, wherein a fluid is configured to move between the first side opening and the second side opening when the probe is in the second position to thereby clean the probe, wherein the first end of the probe is configured to input a plurality of samples into the fluidic pathway from a plurality of sample wells when the probe is in the third position to thereby form a fluid flow stream in the fluidic pathway, and wherein the first end of the probe is configured to introduce aliquots of a separation gas between successive ones of the plurality of samples in the fluid flow stream to configure the fluid flow stream as a separation gas-separated fluid flow stream.

In a third aspect, the present disclosure provides a flow cell module for a flow cytometry apparatus, the flow cell module comprising: (a) a flow cell, (b) an upper manifold positioned upstream of the flow cell, (c) a lower manifold coupled to the upper manifold and moveable in relation to the upper manifold, (d) a sample injection needle having a first end and a second end opposite the first end, (e) a needle adjustment member fixedly coupled to the second end of the sample injection needle and moveably positioned in the lower manifold, wherein an interior of a least a portion of the needle adjustment member is threaded such that a rotation of the needle adjustment member adjusts a position of the first end of the sample injection needle with respect to the flow cell, and (f) a fluidic link connection screw coupled to the needle adjustment member, wherein an interior of the fluidic link connection screw is configured to receive a fluidic pathway.

In a fourth aspect, the present disclosure provides a system comprising: (a) the flow cytometry system of the first aspect, (b) the flow cytometry system of the second aspect, and (c) the flow cell module of the third aspect.

The features, functions, and advantages that have been discussed can be achieved independently in various examples or may be combined in yet other examples, further details of which can be seen with reference to the following description and figures.

### BRIEF DESCRIPTION OF THE DRAWINGS

The novel features believed characteristic of the illustrative examples are set forth in the appended claims. The illustrative examples, however, as well as a preferred mode of use, further objectives and descriptions thereof, will best be understood by reference to the following detailed description of an illustrative examples of the present disclosure when read in conjunction with the accompanying figures.

FIG. 1 is a schematic of an example flow cytometry system.

FIG. 2 illustrates a table and corresponding histogram generated using the data acquired from the two or more side scatter detection modules of the flow cytometry system.

FIG. 3 illustrates the per laser data correlation on a field-programmable gate array (FPGA) level using a global source trigger using the data acquired from the two or more side scatter detection modules of the flow cytometry system.

FIG. 4 illustrates a search time window for adapting to fluidic flow variation using the data acquired from the two or more side scatter detection modules of the flow cytometry system.

FIG. 5 illustrates a step in the data correlation algorithm to correlate the data acquired from the two or more side scatter detection modules of the flow cytometry system.

FIG. 6 illustrates another step in the data correlation algorithm to correlate the data acquired from the two or more side scatter detection modules of the flow cytometry system.

FIG. 7 illustrates another step in the data correlation algorithm to correlate the data acquired from the two or more side scatter detection modules of the flow cytometry system.

FIG. 8A illustrates a collar wash module with the probe in a first position.

FIG. 8B illustrates the collar wash module of FIG. 8A with the probe in a second position.

FIG. 8C illustrates the collar wash module of FIG. 8A with the probe in a third position.

FIG. 9A illustrates a collar wash module with the probe in a first position.

FIG. 9B illustrates the collar wash module of FIG. 9A with the probe in a second position.

FIG. 9C illustrates the collar wash module of FIG. 9A with the probe in a third position.

FIG. 10 illustrates a cross-sectional view of an example flow cell module of the flow of the flow cytometry system.

FIG. 11 illustrates a perspective view of the flow cell module of FIG. 10.

FIG. 12 illustrates a perspective view of a set screw of the flow cell module of FIG. 10.

### DETAILED DESCRIPTION

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts were described in conjunction with specific examples, it will be understood that these examples are not intended to be limiting. All examples of any aspect of the invention can be used in combination, unless the context clearly dictates otherwise.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment” or “one example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

As used herein, “coupled” means associated directly as well as indirectly. For example, a member A may be directly associated with a member B, or may be indirectly associated therewith, e.g., via another member C. It will be understood that not all relationships among the various disclosed elements are necessarily represented.

Example methods and systems are described herein. It should be understood that the words “example,” “exemplary,” and “illustrative” are used herein to mean “serving as an example, instance, or illustration.” Any example or feature described herein as being an “example,” being “exemplary,” or being “illustrative” is not necessarily to be construed as preferred or advantageous over other examples or features. The examples described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to”. Words using the singular or plural number also include the plural and singular number, respectively.

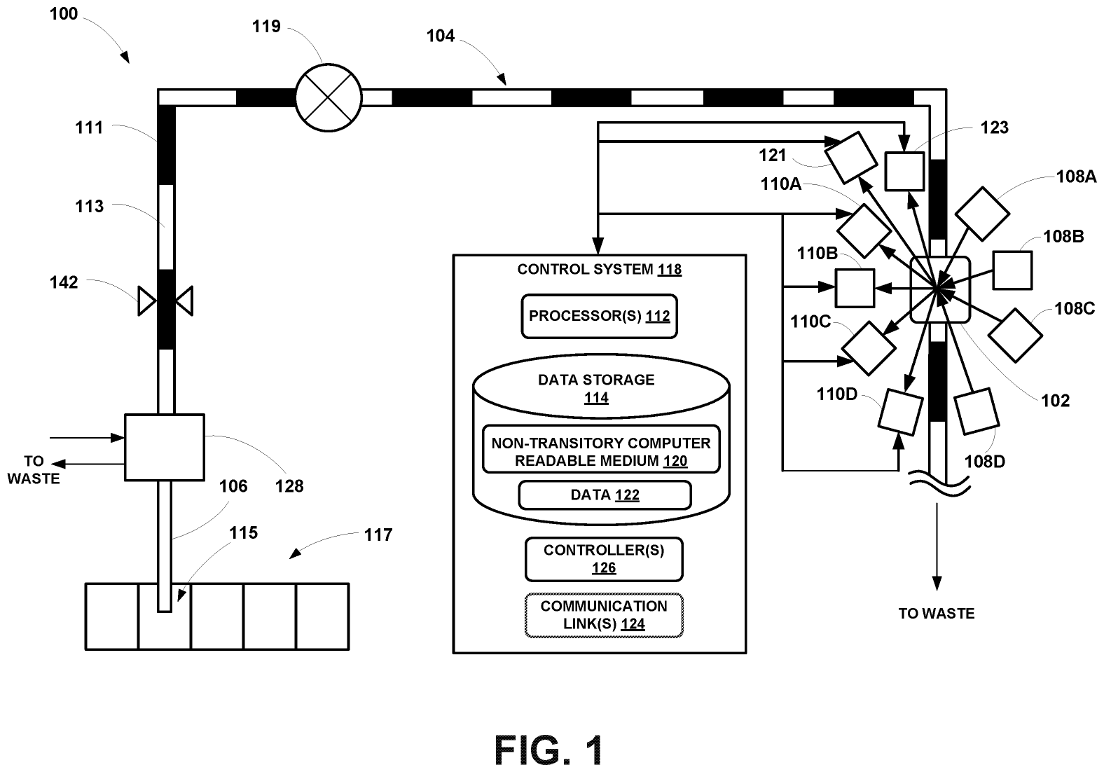

In FIG. 1, referred to above, solid lines, if any, connecting various elements and/or components may represent mechanical, electrical, fluid, optical, electromagnetic and other couplings and/or combinations thereof. As used herein, “coupled” means associated directly as well as indirectly. For example, a member A may be directly associated with a member B, or may be indirectly associated therewith, e.g., via another member C. It will be understood that not all relationships among the various disclosed elements are necessarily represented. Accordingly, couplings other than those depicted in the block diagrams may also exist. Dashed lines, if any, connecting blocks designating the various elements and/or components represent couplings similar in function and purpose to those represented by solid lines; however, couplings represented by the dashed lines may either be selectively provided or may relate to alternative examples of the present disclosure. Likewise, elements and/or components, if any, represented with dashed lines, indicate alternative examples of the present disclosure. One or more elements shown in solid and/or dashed lines may be omitted from a particular example without departing from the scope of the present disclosure. Environmental elements, if any, are represented with dotted lines. Virtual (imaginary) elements may also be shown for clarity. Those skilled in the art will appreciate that some of the features illustrated in FIG. 1 may be combined in various ways without the need to include other features described in FIG. 1, other drawing figures, and/or the accompanying disclosure, even though such combination or combinations are not explicitly illustrated herein. Similarly, additional features not limited to the examples presented, may be combined with some or all of the features shown and described herein.

For the purposes of the present invention, the term “particles” as used herein refers to small objects with physical size between 1 nm and 1 mm including, but not limited to, molecules, cells, proteins, protein aggregates, microbes, viruses, microspheres, microbeads, cellular components such as nuclei, mitochondria, chemical compounds, and chemical aggregates, etc.

As used herein “sample” refers to any quantity of liquid which may contain particles of interest or marker particles that are detectable by a particle analyzer. More specifically a sample may include a fluid solution or suspension containing particles of interest or marker particles to be detected and/or analyzed using a method and/or apparatus disclosed herein. The particles of interest in a sample may be tagged, such as with a fluorescent tag. The particles of interest may also be bound to a bead, a receptor, or other useful protein or polypeptide, or may just be present as free particles, such as particles found naturally in a cell lysate, purified particles from a cell lysate, particles from a tissue culture, etc. The sample may include chemicals, either organic or inorganic, used to produce a reaction with the particles of interest. When the particles of interest are biomaterials, drugs may be added to the samples to cause a reaction or response in the biomaterial particles. The chemicals, drugs or other additives may be added to and mixed with the samples when the samples are in sample source wells or the chemicals, drugs or other additives may be added to the samples in the fluid flow stream after the samples have been uptaken by the autosampler.

For the purposes of the present invention, the term “well” as used herein may include any vessel for containing a sample, such as a chamber, dish, tube, bottle, vial, reservoir trough, or a well on a microtiter plate.

As used herein “microplate” and “plate” refer to a structure capable of holding one or more samples to be analyzed or aliquot of marker particles.

As used herein, the term “fluidic pathway” or “conduit” refers to device such as a tube, channel, etc. through which a fluid stream flows. A fluidic pathway may be composed of several separate devices, such as a number of connected or joined pieces of tubing or a single piece of tubing, alone or in combination with channels or other different devices.

By the term “about,” “approximately,” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, in one embodiment, the term “about” can refer to ±5% of a given value.

Various other features of the example systems discussed above, as well as methods for using these systems, are also described hereinafter with reference to the accompanying figures. Illustrative, non-exhaustive examples, which may or may not be claimed, of the subject matter according the present disclosure are provided below.

With reference to the Figures, FIG. 1 illustrates an example flow cytometry system 100. As shown in FIG. 1, the flow cytometry system 100 includes a flow cell 102 and a fluidic pathway 104 in fluid communication with the flow cell 102. The flow cytometry system 100 further includes a probe 106 in fluid communication with the fluidic pathway 104. The probe is configured to input a plurality of samples and aliquots of a separation gas between successive ones of the plurality of samples into the fluidic pathway 104. The flow cytometry system 100 further includes two or more lasers 108A-108D positioned such that an illumination spot of each of the two or more lasers 108A-108D is directly on the flow cell 102. The flow cytometry system 100 further includes two or more side scatter detection modules 110A-110D in communication with the two or more lasers 108A-108D. Although FIG. 1 illustrates the number of the two or more lasers and the number of the two or more side scatter detection modules to be four, this number may be two, three, four, or five as non-limiting examples.

In operation, the probe 106 may take up a sample 111 from a sample well 115 in the well plate 117, for example, and then advance the sample 111 into the fluidic pathway 104. A pump 119 may then drive a fluid flow stream including samples 111 from the well 115 through the fluidic pathway 104 to the flow cell 102. In such an embodiment, the flow cell 102 is in fluid communication with the probe 106 via the fluidic pathway 104, and the flow cytometry system 100 is configured to focus the fluid flow stream delivered by the fluidic pathway 104 from the probe 106 and selectively analyze the particles in each of the plurality of samples 111 as the fluid flow stream passes through the flow cell 102.

As discussed above, the flow cytometry system 100 further includes two or more lasers 108A-108D positioned such that an illumination spot of each of the two or more lasers 108A-108D is directly on the flow cell 102. The two or more lasers 108A-108D are configured to examine individual samples flowing from the flow cell 102, as discussed in additional detail below. When samples 111 pass through the illumination spot of two or more lasers 108A-108D, the particles in the samples 111 are sensed by various components of the flow cytometry system 100. Forward scattered light is detected by one or more forward scatter detectors 121. Fluorescence emitted from tagged particles in the flow cell 102 is detected by one or more fluorescence detectors 123. In one example, the one or more fluorescence detectors 123 comprise one or more photomultiplier detectors. Side scattered light is detected by the two or more side scatter detectors 110A-110D. In contrast, when the separation gas 113 passes through the illumination spot of two or more lasers 108A-108D, no particles are sensed. Therefore, a graph of the data points of fluorescence sensed versus time for a series of samples analysed using a flow cytometer will form distinct groups, each aligned with the time that a sample containing particles passes through the illumination spot of two or more lasers 108A-108D. Such graphs can be generated by the output of both the one or more forward scatter detectors 121, the one or more fluorescence detectors 123, and/or the one or more side scatter detectors 110A-110D.

In one example, the pump 119 comprises a peristaltic pump. In one embodiment, such a peristaltic pump may be operated in a manner that reduces pulsatile flow, thereby improving the sample characteristics in the flow cytometry system 100. In another embodiment, the pump 119 comprises a gear pump. In yet another example, the pump comprises a syringe pump. Although the pump 119 is shown before the flow cell 102 in FIG. 1, in another embodiment the pump 119 may be positioned downstream of the flow cell 102. Further, additional pumps may be added to the flow cytometry system 100 to perform various functions. For example, a combination of one or more peristaltic pumps, one or more gear pumps, and/or one or more syringe pumps may be used to transport samples through the fluidic pathway 104.

In one embodiment, the fluidic pathway 104 may be made of an elastomer tubing, such as nitrile (NBR), Hypalon, Viton, silicone, polyvinyl chloride (“PVC”), Ethylene-Propylene-Diene-Monomer (“EPDM”), EPDM+polypropylene, polyurethane or natural rubber, among other possibilities. An example of such a tube may be a polyvinyl chloride (PVC) tube having an inner diameter of about 0.01 to 0.03 inches and a wall thickness of about 0.01 to 0.03 inches. In one embodiment, a preferred tube for a fluidic pathway 104 may be a PVC tube having an inner diameter of about 0.02 inches and a wall thickness of about 0.02 inches.

As shown in FIG. 1, fluidic pathway 104 includes a fluid flow stream with a series of samples 111 each separated by aliquots of a separation gas 113, such as an air bubble as a non-limiting example. The separation gas 113 may be formed by allowing probe 106 to intake air (or other gas) in between intaking sample material from each of sample wells 115. As such, the probe 106 is used introduce aliquots of the separation gas 113 between successive ones of the samples 111 in the fluid flow stream to configure the fluid flow stream in the fluidic pathway 104 as a separation gas-separated fluid flow stream.

As further shown in FIG. 1, the flow cytometry system 100 may include processor(s) 112, data storage 114, and controller 126, which together may be part of a control system 118. Processor(s) 112 may operate as one or more general-purpose hardware processors or special purpose hardware processors (e.g., digital signal processors, application specific integrated circuits, etc.). The processor(s) 112 may be configured to execute non-transitory computer readable medium 120, and manipulate data 122, both of which are stored in the data storage 114. The processor(s) 112 may also directly or indirectly interact with other components of the flow cytometry system 100, such as communication link(s) 124 as a non-limiting example.

The data storage 114 may be one or more types of hardware memory. For example, the data storage 114 may include or take the form of one or more computer-readable storage media that can be read or accessed by processor(s) 112. The one or more computer-readable storage media can include volatile and/or non-volatile storage components, such as optical, magnetic, organic, or another type of memory or storage, which can be integrated in whole or in part with processor(s) 112. In some implementations, the data storage 114 can be a single physical device. In other implementations, the data storage 114 can be implemented using two or more physical devices, which may communicate with one another via wired or wireless communication. As noted previously, the data storage 114 may include the non-transitory computer readable medium 120 and the data 122. The data 122 may be any type of data from the flow cytometry system 100, such as configuration data, sensor data, and/or diagnostic data, among other possibilities.

The controller 126 may include one or more electrical circuits, units of digital logic, computer chips, and/or microprocessors that are configured to (perhaps among other tasks), interface between any combination of the various components of the flow cytometry system 100. In some implementations, the controller 126 may be a purpose-built embedded device for performing specific operations with one or more subsystems of the flow cytometry system 100

The control system 118 may monitor and physically change the operating conditions of the flow cytometry system 100. In doing so, the control system 118 may serve as a link between portions of the flow cytometry system 100. In some instances, the control system 118 may serve as an interface between the flow cytometry system 100 and another computing device. Further, the control system 118 may serve as an interface between the flow cytometry system 100 and a user.

In some implementations, the control system 118 of the flow cytometry system 100 may also include communication link(s) 124 configured to send and/or receive information. The communication link(s) 124 may transmit data indicating the state of the various components of the flow cytometry system 100. For example, information from the two or more side scatter detection modules 110A-110D may be transmitted via the communication link(s) 124 to a separate device. Other diagnostic information indicating the integrity or health of various components of the two or more side scatter detection modules 110A-110D may be transmitted via the communication link(s) 124 to an external communication device.

In some implementations, the flow cytometry system 100 may receive information at the communication link(s) 124 that is then processed by the processor(s) 112. The received information may indicate data that is accessible by the processor(s) 112 during execution of the instructions stored by the non-transitory computer readable medium 120. Further, the received information may change aspects of the controller 126 that may affect the operating parameters of various components of the flow cytometry system 100. In some cases, the received information may indicate a query requesting a particular piece of information (e.g., the operational state of one or more of the components of the flow cytometry system 100). The processor(s) 112 may subsequently transmit the particular piece of information back out the communication link(s) 124.

In some cases, the communication link(s) 124 may include a wired connection. As such, the flow cytometry system 100 may include one or more ports to interface the communication link(s) 124 to an external device. The communication link(s) 124 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, Bluetooth, or a near-field communication (NFC) device.

During operation, the control system 118 may communicate with other systems of the flow cytometry system 100 via wired or wireless connections and may further be configured to communicate with one or more users of system. As one possible illustration, the control system 118 may receive an input (e.g., from the two or more side scatter detection modules 110A-110D of the flow cytometry system 100) indicating a change in operational status of the flow cytometry system 100. The input to control system 118 may be received via the communication link(s) 124. Based on this input, the control system 118 may perform operations to cause the flow cytometry system 100 to perform one or more tasks.

Operations of the control system 118 may be carried out by the processor(s) 112. Alternatively, these operations may be carried out by the controller 126, or a combination of the processor(s) 112 and the controller 126. In some implementations, the control system 118 may partially or wholly reside on a device other than the flow cytometry system 100, and therefore may at least in part control the flow cytometry system 100 remotely. Communication link(s) 124 may be used at least in part to carry out the remote communication.

As described above, the flow cytometry system 100 includes a processor 112 in communication with the two or more side scatter detection modules 110A-110D, and a non-transitory computer readable medium 120 having stored therein instructions that are executable to cause the processor 112 to perform functions. In particular, the functions may include (i) detecting, via a first side scatter detection module 110A of the two or more side scatter detection modules, a first sample of the plurality of samples 111 in the fluidic pathway 104 at a first timestamp, (ii) detecting, via a second side scatter detection module 110B of the two or more side scatter detection modules, the first sample of the plurality of samples 111 in the fluidic pathway 104 at a second timestamp after the first timestamp, and (iii) determining a time delta between a first laser 108A of the two or more lasers and a second laser 108B of the two or more lasers based on a difference between a plurality of first timestamps and a plurality of second timestamps. In one example, the time delta ranges from about 50 μs to about 200 μs between any two adjacent lasers of the two or more lasers 108A-108D.

In one example, the time delta is determined based on a standard deviation of the difference between the plurality of first timestamps and the plurality of second timestamps. In another example, the time delta is determined based on a mean of the difference between the plurality of first timestamps and the plurality of second timestamps.

In one example, a fiber optic cable, collecting a scatter light signal from the flow cell 102 illuminated by a given laser of the two of more lasers 108A-108D, connects with a given side scatter detection module of the two or more side scatter detection modules 110A-110D.

In one example, the flow cytometry system 100 includes a plurality of photomultiplier detectors, a plurality of photodiode detectors, a filter, an analog-to-digital converter, and a field-programmable gate array (FPGA). In such an example, the filter comprises one or more of a bandpass filter, a longpass filter, and a dichroic filter.

In one particular example, the plurality of photomultiplier detectors and the plurality of photodiode detectors comprises two lasers (one blue and one red), eight photomultiplier detectors (five in blue and three in red), and three photodiode detectors (one forward scatter detector in blue, one side scatter detector in blue, and one side scatter detector in red). In another example, the plurality of photomultiplier detectors and the plurality of photodiode detectors comprises three lasers (one violet, one blue, and one red), sixteen photomultiplier detectors (eight in violet, five in blue, and three in red), and four photodiode detectors (one forward scatter detector in blue, one side scatter detector in violet, one side scatter detector in blue, and one side scatter detector in red). In another example, the plurality of photomultiplier detectors and the plurality of photodiode detectors comprises four lasers (one violet, one blue, one yellow, and one red), twenty-two photomultiplier detectors (eight in violet, five in blue, six in yellow, and three in red), and five photodiode detectors (one forward scatter detector in blue, one side scatter detector in violet, one side scatter detector in blue, one side scatter detector in yellow, and one side scatter detector in red). These example number of components are given for illustrative purposes only, and other numbers of these features are possible as well.

In one example, a number of the two or more lasers 108A-108D is equal to a number of the two or more side scatter detection modules 110A-110D. In one example, the number of the two or more lasers 108A-108D and the number of the two or more side scatter detection modules 110A-110D is two. In such an example, the first laser 108A is configured to illuminate only light having a red wavelength, and the second laser 108B is configured to illuminate only light having a blue wavelength.

In another example, the number of the two or more lasers 108A-108D and the number of the two or more side scatter detection modules 110A-110D is three. In such an example, the third laser 108C is configured to illuminate only light having a violet wavelength. In such an example, the non-transitory computer readable medium 120 causes the processor 112 to further perform functions including (i) detecting, via a third side scatter detection module 110C of the two or more side scatter detection modules, the first sample of the plurality of samples 111 in the fluidic pathway 104 at a third timestamp after the first timestamp, and (ii) determining a second time delta between the first laser 108A of the two or more lasers and a third laser 108C of the two or more lasers based on a difference between a plurality of first timestamps and a plurality of third timestamps.

In another example, the number of the two or more lasers 108A-108D and the number of the two or more side scatter detection modules 110A-110D is four. In such an example, the fourth laser 108D is configured to illuminate only light having a yellow wavelength. In such an example, the non-transitory computer readable medium 120 causes the processor 112 to further perform functions including (i) detecting, via a fourth side scatter detection module 110D of the two or more side scatter detection modules, the first sample of the plurality of samples 111 in the fluidic pathway 104 at a fourth timestamp after the first timestamp, and determining a third time delta between a first laser 108A of the two or more lasers and a fourth laser 108D of the two or more lasers based on a difference between a plurality of first timestamps and a plurality of fourth timestamps.

In another example, the number of the two or more lasers 108A-108D and the number of the two or more side scatter detection modules 110A-110D is five. In such an example, the fifth laser is configured to illuminate only light having an ultraviolet wavelength. In such an example, the non-transitory computer readable medium 120 causes the processor 112 to further perform functions including (i) detecting, via a fifth side scatter detection module of the two or more side scatter detection modules, the first sample of the plurality of samples 111 in the fluidic pathway 104 at a fifth timestamp after the first timestamp, and determining a fourth time delta between a first laser 108A of the two or more lasers and a fifth laser of the two or more lasers based on a difference between a plurality of first timestamps and a plurality of fifth timestamps.

In another example, the non-transitory computer readable medium 120 causes the processor 112 to further perform functions including correlating, using the time delta, data corresponding to the first sample detected by the first side scatter detection module 110A with data corresponding to the first sample detected by the second side scatter detection module 110B to create a single event data for the first sample.

In another example, the non-transitory computer readable medium 120 causes the processor 112 to further perform functions including (i) determining, based on one or more properties of the fluid in the fluidic pathway 104, a presence of a separation gas 113 in the fluid in the fluidic pathway 104, (ii) generating separation gas timing data comprising the detected one or more properties of the fluid in the fluidic pathway 104 and a corresponding timestamp, and (iii) identifying a respective sample well of the plurality of sample wells 115, based, at least in part, on the separation gas timing data.

In another example, the non-transitory computer readable medium 120 causes the processor 112 to further perform functions including correlating the first timestamp with the second timestamp to determine a detection event of the first sample of the plurality of samples. In one example, correlating the first timestamp with the second timestamp comprises (i) accumulating data from the first side scatter detection module 110A and the second side scatter detection module 110B for a predefined time interval in separate queues for each side scatter detection module, and (ii) combining data from the first side scatter detection module 110A and the second side scatter detection module 110B if the first timestamp and the second timestamp are within a threshold time difference.

Each flow cytometry system 100 can have some small variation in the flow rate due to peristaltic pump or gear pump related tubing wear, tubing condition, variation in pump output per machine, and other conditions. The use of the two or more side scatter detection modules 110A-110D as described above allows the flow cytometry system 100 to adaptively measure the time deltas between the laser spot locations to enable automatic adaption to fluidic flow variation. In addition to the initial time delta calibration, the flow cytometry system 100 uses the two or more side scatter detection modules 110A-110D to correlate sample data across the multiple laser spot locations.

The time delta calculation is used to synchronize events from lasers that are physically separated on the fluidic pathway 104. The typical temporal distance between lasers in the flow cytometry system 100 may be around 60-95 μs, but can vary due to difference in stream flow and small differences in the mechanical construction and laser point angle. The following algorithm is used to determine the actual time offsets between the lasers 108A-108D in the flow cytometry system 100 under real conditions.

The calculation uses side scatter channels only and works best with a sparse event stream (low concentration). The side scatter channels are configured in ‘threshold mode’ so that they are self-triggering. For each event, each laser will generate a separate peak with a time stamp specific to its laser.

For purposes of description, the lowest numbered board is designated as board 0. Once the algorithm is initiates, data is collected for 4096 peaks for all attached boards. The data is then sorted by timestamp. Then the timestamp deltas for each board relative to board 0 are calculated and stored in the table. A histogram is formed for each board and the time delay corresponding to the histogram peak is used to calculate the mean and standard deviation of the time delay for each board. The number of peaks for each board as well as the standard deviation are further used to indicate the quality of the measurement.

Below is a description of an algorithm used to calculate the time delta described above, according to a non-limiting example.

### System Setup

1. Set all side scatter channels to threshold mode with time offsets=0 and disable local peak search.

2. Set the channel list to VLSSC, BLSSC, YLSSC, RLSSC so that only the side scatter channels for the attached lasers are enabled.

3. Configure the system for 32 byte packets.

4. Change the network transfer size to small packets (4096).

### Processing

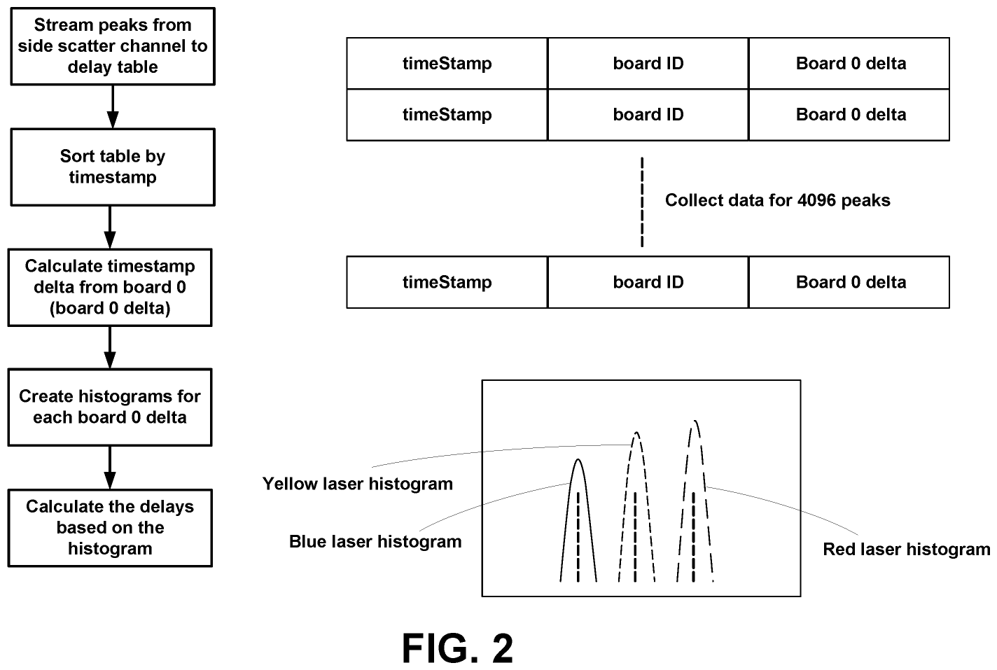

Referring to FIG. 2, a table is created with 3 entries: (1) Board ID, (2) Timestamps, and (3) Timestamp delta.

Next, commence the data stream. During streaming, each board is polled sequentially and each peak received is added to the table with its Board ID and timestamp in the order it is received. Data is collected until the table is filled. Currently, this is set to 4096 peaks but other number of peaks is possible as well.

Once the table is filled, the data may be parsed by (1) sorting the table into timestamp order, (2) determining the lowest numbered board in the system—call it board 0, and (3) for each event, calculate the time deltas relative to board 0 and create a delta-time histogram for each of the boards (currently 1024 points). Next, for every entry for board 0, look for subsequent peaks from the other boards and (1) calculate and store the timestamp delta between this and the prior board 0 timestamp, and (2) add the calculated delta to the histogram for the board.

Using the histograms shown in FIG. 2, for each of the boards (excluding board 0, which in this case corresponds to the violet laser), the delta time for the board corresponding to the peak in the histogram table is acquired. For each of the non 0 boards, the standard deviation as a marker of quality of the delta time. The standard deviation and mean are calculated over a +/−4 μs window. Further, the data may be qualified by requiring a minimum of table size/8 (512) points for each board. The standard deviation and mean delta values may be returned for each board relative to the second laser board.

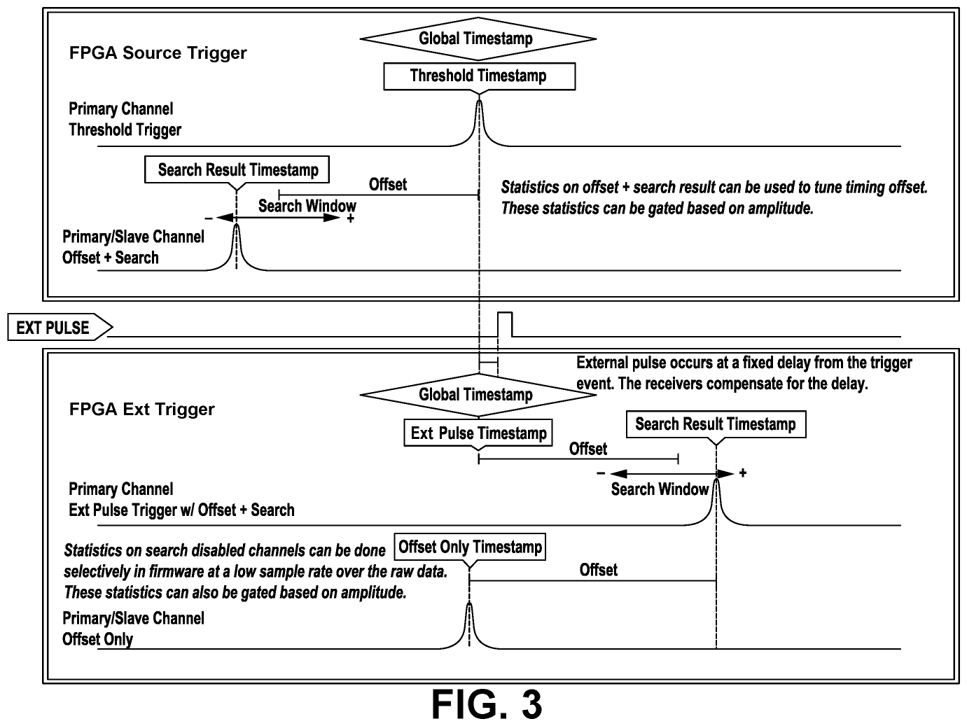

FIG. 3 illustrates the per laser data correlation on a field-programmable gate array (FPGA) level using a global source trigger.

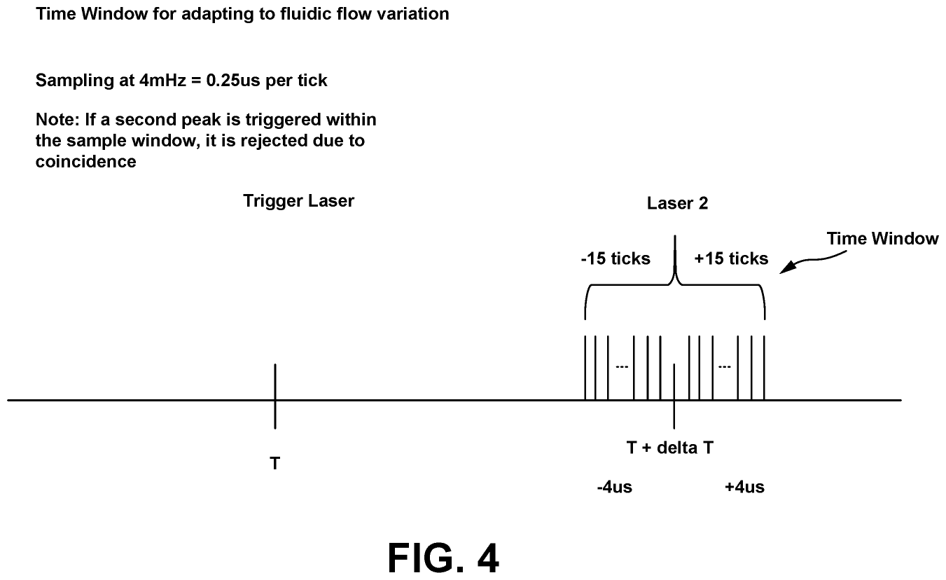

FIG. 4 illustrates a search time window for adapting to fluidic flow variation. Note that if a second peak is triggered within the sample window, it is rejected due to coincidence.

### Data Correlation Algorithm

Data packets received from a single FPGA are in a time ordered sequence. However, there is no synchronization of transmissions between the FPGA's. Packets are sent based on network traffic and buffering capability on the FPGA boards.

Data from the different FPGA's may not arrive at the network host in a time ordered manner. It is therefore necessary to time align the separate FPGA packets to ensure that peaks are combined into events before being transferred to the ForeCyt analysis software in an ordered format know as FCS data.

An FCS event consists of the peak data from all the lasers in the system corresponding to a given timestamp. To create the FCS events, a sorting process is implemented. This sorting process is accomplished by simply holding on to data for a predefined time interval (currently 1.00 seconds) in separate queues for each FPGA, then combining packets from different FPGA's with matching timestamps before forwarding them to ForeCyt as FCS events.

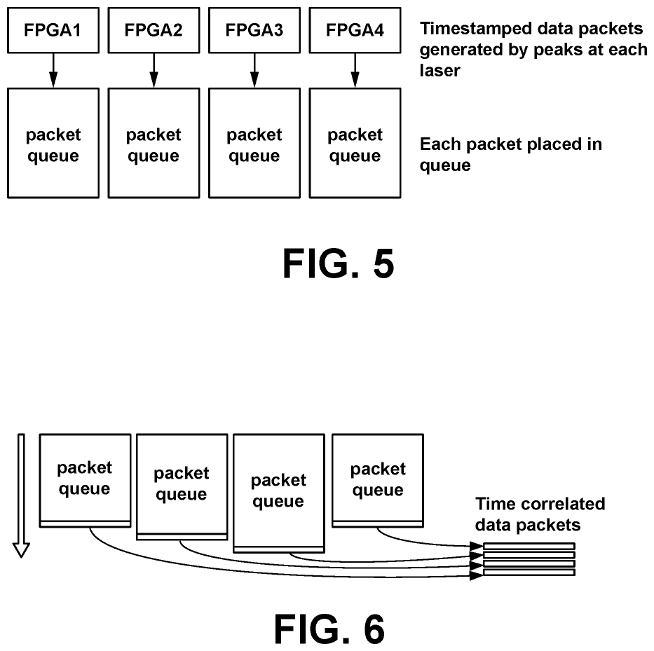

Data arriving from each FPGA is stored in separate queues. Note that packets from an FPGA are guaranteed to be ordered incrementally in time. Thus, each packet in the queue will be implicitly ordered by this mechanism, as shown in FIG. 5.

Each queue will be receiving data from the FPGAs as it is available. When sufficient time has elapsed to guarantee that data is available in each queue, a pass is done to peek at the front of each queue and find the lowest time stamp. This timestamp, T, will be used to correlate a group of packets in time. Packets are only dequeued if the timestamp tolerance is within 10 timesteps of T. Otherwise, they remain in the queue. The dequeued packets are then added into a group of correlated packets that will be used to form an event, as shown in FIG. 6.

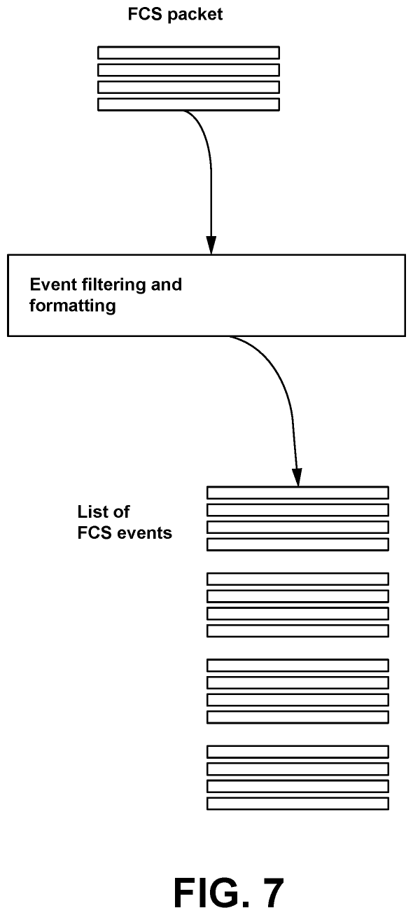

Each group of correlated packets is filtered and formatted into an FCS event. Each FCS event is then added to a list of FCS events that can be transmitted to ForeCyt, as shown in FIG. 7.

In one example, before qualifying the FCS event, there are two software filters that can be applied to user selected channels. The software filters specify the minimum height value for a specified channel that must be met for the event to be accepted. Further, the software filters may include a data integrity filter that checks for incomplete events. For example, if data is missing from any enabled FPGA (laser), then the event is discarded.

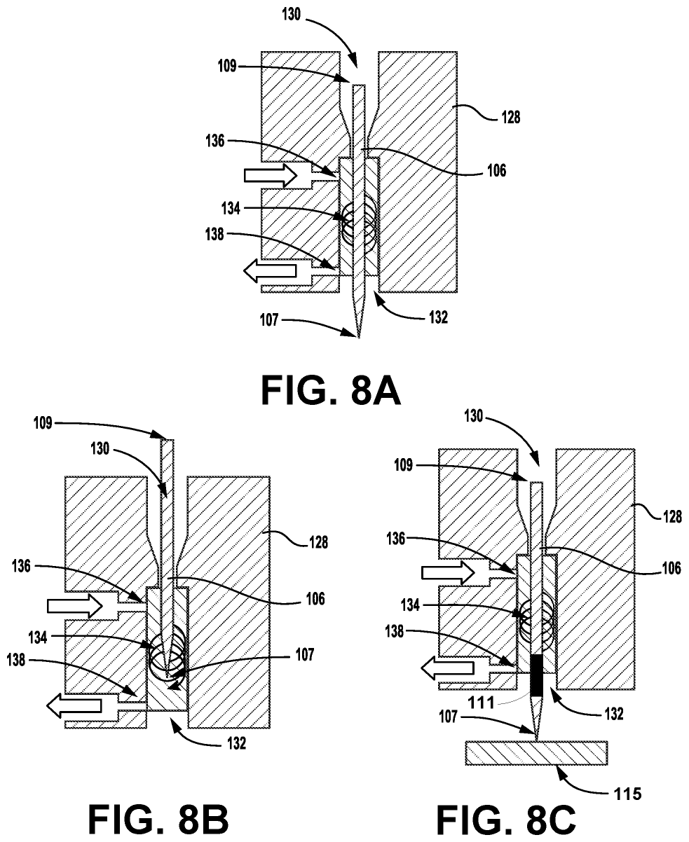

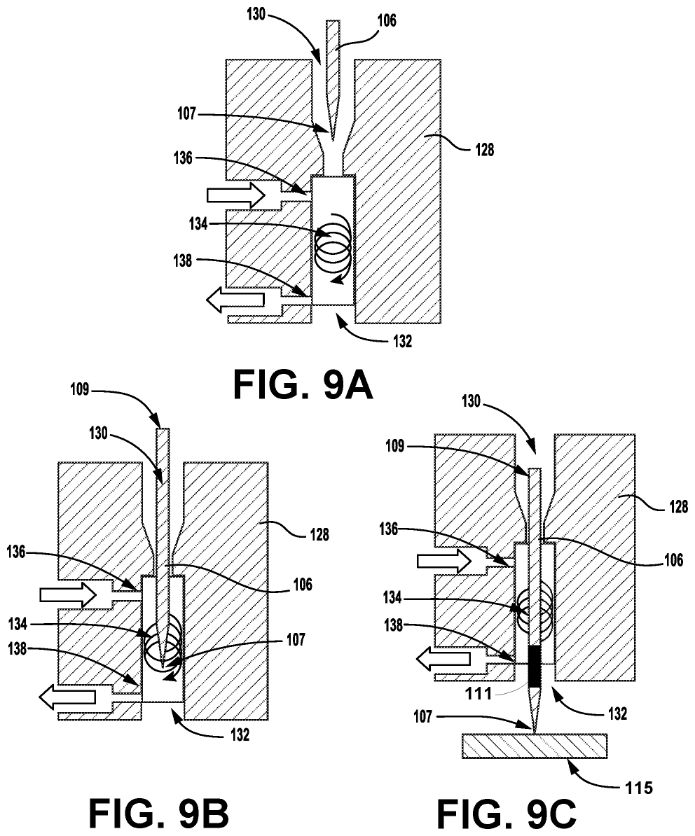

With reference to FIGS. 8A-9C, the probe 106 of the flow cytometry system 100 includes a first end 107 and a second end 109 opposite the first end 107. The second end 109 of the probe 106 is in fluid communication with the fluidic pathway 104. The flow cytometry system 100 may further include a collar wash module 128 positioned adjacent the probe 106. As shown in FIGS. 8A-9C, the collar wash module 128 includes a top opening 130, a bottom opening 132 in fluid communication with the top opening 130 via a common shaft 134, a first side opening 136, and a second side opening 138 in fluid communication with the first side opening 136 via the common shaft 134.

In use, as shown in FIGS. 8A-9C, the probe is configured to transition from a first position (FIGS. 8A, 9A) in which the first end 107 of the probe 106 is positioned outside of the collar wash module 128 to a second position (FIGS. 8B, 9B) in which the first end 107 of the probe 106 is positioned inside of the collar wash module 128 between the first side opening 136 and the second side opening 138 to a third position (FIGS. 8C, 9C) in which the first end 107 of the probe 106 is positioned outside of the collar wash module 128. In one example, as shown in FIGS. 8C and 9C, the first end 107 of the probe 106 extends through the bottom opening 132 in the third position. In use, in the third position shown in FIGS. 8C and 9C, the first end 107 of the probe 106 can extend through the bottom opening 132 and into the sample well 115 to draw a sample 111 to feed into the flow cell 102 for analysis.

A fluid is configured to move between the first side opening 136 and the second side opening 138 when the probe 106 is in the second position to thereby clean the probe 106. In particular, the fluid may clean an external surface of the probe 106 via liquid in the collar wash module 128, and further clean the fluidic pathway 104 by sipping liquid from the collar wash module 128 through the first end 107 of the probe 106. The fluid may be a buffer or a decontamination solution, as non-limiting examples. In one example, as shown in FIGS. 8B and 9B, the fluid is configured to enter the first side opening 136 and exit the second side opening 138 when the probe 106 is in the second position to thereby clean the probe 106. In another example, the fluid is configured to enter the second side opening 138 and exit the first side opening 136 when the probe 106 is in the second position to thereby clean the probe 106.

The first end 107 of the probe is configured to input a plurality of samples 111 (shown in FIG. 1) into the fluidic pathway 104 from a plurality of sample wells 115 when the probe 106 is in the third position to thereby form a fluid flow stream in the fluidic pathway 104. The first end 107 of the probe 106 is further configured to introduce aliquots of a separation gas 113 between successive ones of the plurality of samples 111 in the fluid flow stream to configure the fluid flow stream as a separation gas-separated fluid flow stream. In one example, the aliquots of a separation gas 113 are introduced between successive ones of the plurality of samples 111 when the probe 106 is in the first position.

In one example, as shown in FIG. 8A, in the first position the first end 107 of the probe 106 extends through the bottom opening 132 of the collar wash module 128. In another example, as shown in FIG. 9A, in the first position the first end 107 of the probe 106 extends through the top opening 130 of the collar wash module 128 but above the first side opening 136.

In one example, the probe 106 is configured to transition between the second position and the third position between each of the plurality of sample wells 115. In another example, the probe 106 is configured to transition between the first position and second position multiple times before transitioning to the third position. In such an example, the fluid is configured to move between the first side opening 136 and the second side opening 138 each time the probe 106 is in the second position to thereby clean the probe 106 multiple times between successive sample pulls. In one example, a user may select how many times the probe 106 enters the second position to be cleaned between successive sample pulls.

In one example, the flow cytometry system 100 further includes a pump 119 configured to pull the fluid through the collar wash module 128, from the second side opening 138 of the collar wash module 128, and into a waste container. The collar wash module 128 described herein may help decrease sample carryover from one well to another by washing the probe 106 and tubing inner surface. Further, as described above, the collar wash module 128 has the ability to backflush the tubing with the sheath liquid from flow cell by reversing the pump 119, while the backflush liquid in the sample tubing will go to the collar wash module 128 from the probe tip and will be sucked into the waste tank (this will help maintain the sample tubing in a well/clean condition without clogging issues).

In one example, the non-transitory computer readable medium 120 causes the processor 112 to further perform functions including (i) detecting a clog in the fluidic pathway 104, and (ii) pumping, via the pump 119, a fluid through the collar wash module 128, into the second end 109 of the probe 106, and into a waste container to remove the clog from the fluidic pathway 104.

In one example, such a clog is detected via one or more bubble sensors 142 positioned on the fluidic pathway 104. The one or more bubble sensors 142 can be used to look for undesirable bubble breakup as well as for calibration for volumetric sampling. The one or more bubble sensors 142 may be configured to record a sample count and an air gap count. If the sample count and air gap count detected by the one or more bubble sensors 142 shows that there is no movement of air gaps and/or samples, the flow cytometry system 100 may determine that there is a clog in the fluidic pathway 104 and give the user a warning and/or automatically commence clog removal procedures.

In one example, the non-transitory computer readable medium 120 causes the processor 112 to further perform functions including (i) determining, via one or more bubble sensors 142 positioned on the fluidic pathway 104, a presence of the separation gas 113 in the fluid in the fluidic pathway 104, (ii) generating separation gas timing data comprising the detected one or more properties of the fluid in the fluidic pathway 104 and a corresponding timestamp, and (iii) identifying a respective sample well of the plurality of sample wells, based, at least in part, on the separation gas timing data.

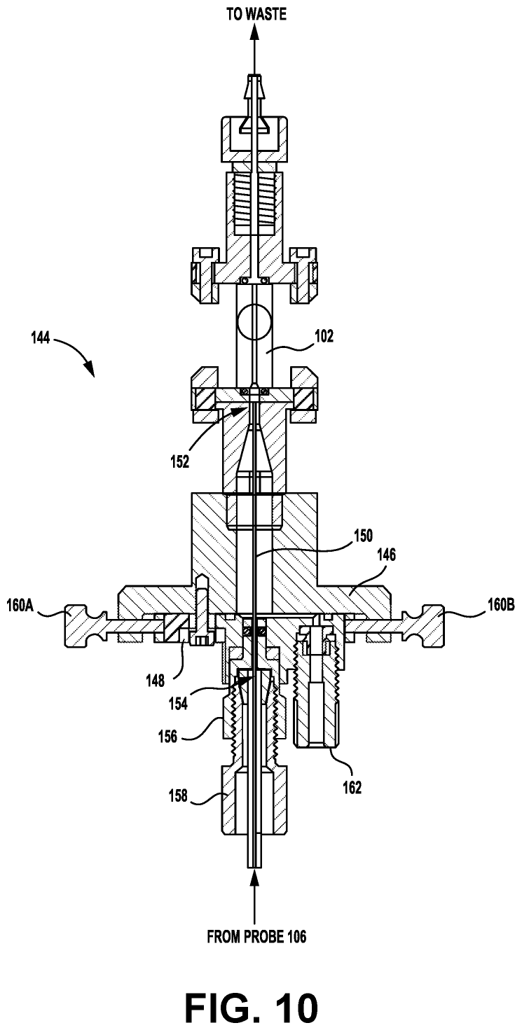

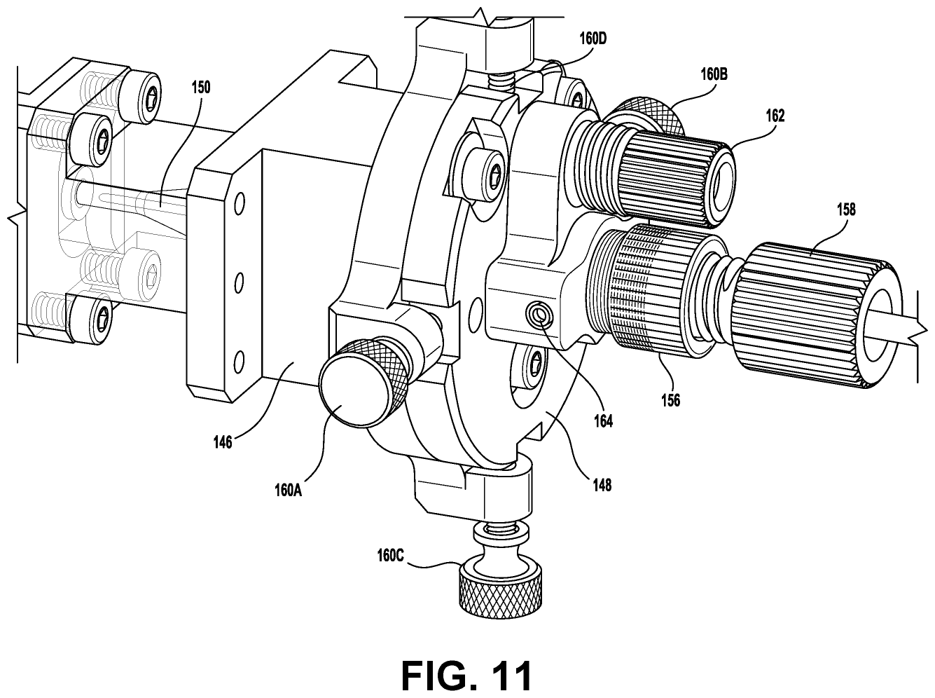

With reference to FIGS. 10-12, the flow cytometry system 100 may further include a flow cell module 144. The flow cell module 144 includes the flow cell 102 as described above. As shown in FIGS. 10-12, the flow cell module 144 further includes an upper manifold 146 positioned upstream of the flow cell 102. The flow cell module 144 further includes a lower manifold 148 coupled to the upper manifold 146 and moveable in relation to the upper manifold 146. The flow cell module 144 further includes a sample injection needle 150 having a first end 152 and a second end 154 opposite the first end 152. The flow cell module 144 further includes a needle adjustment member 156 fixedly coupled to the second end 154 of the sample injection needle 150 and moveably positioned in the lower manifold 148. An interior of a least a portion of the needle adjustment member 156 is threaded such that a rotation of the needle adjustment member 156 adjusts a position of the first end 152 of the sample injection needle 150 with respect to the flow cell 102. In one example, the first end 152 of the sample injection needle 150 can be adjusted +/−10 mm by rotating the needle adjustment member 156 in or out of the lower manifold 148.

The flow cell module 144 further includes a fluidic link connection screw 158 coupled to the needle adjustment member 156. An interior of the fluidic link connection screw 158 is configured to receive the fluidic pathway 104. In one example, an exterior of at least a portion of the fluidic link connection screw 158 includes threads complementary to the threads of the needle adjustment member 156.

In one example, as shown in FIG. 10, a first end of the flow cell 102 positioned adjacent the first end 152 of the sample injection needle 150 is coned shaped. Such an arrangement may help ensure that the fluid flow through the flow cell is laminar.

In one example, as shown in FIGS. 10-11, the lower manifold 148 is moveable in relation to the upper manifold 146 via four adjustment screws 160A-160D configured to move the lower manifold 148 with respect to the upper manifold 146 in an x-y direction. Since the sample injection needle 150 is fixed with respect to the lower manifold 148, such a movement further adjusts a position of the first end 152 of the sample injection needle in an x-y direction with respect to the flow cell 102. In contrast, the rotation of the needle adjustment member 156 adjusts the position of the first end 152 of the sample injection needle 150 with respect to the flow cell 102 in a z-direction.

In one example, as shown in FIGS. 10-11, the lower manifold 148 includes an input port 162 for a sheath line. In one example, the upper manifold 146, the lower manifold 148, and the sample injection needle 150 each comprise stainless steel. In another example, the sample injection needle 150 comprises a one-piece design. The sample injection needle 150 may be either glued or welded to the needle adjustment member 156. When the needle adjustment member 156 is rotated in a z-direction, the sample injection needle 150 will also rotate in the z-direction.

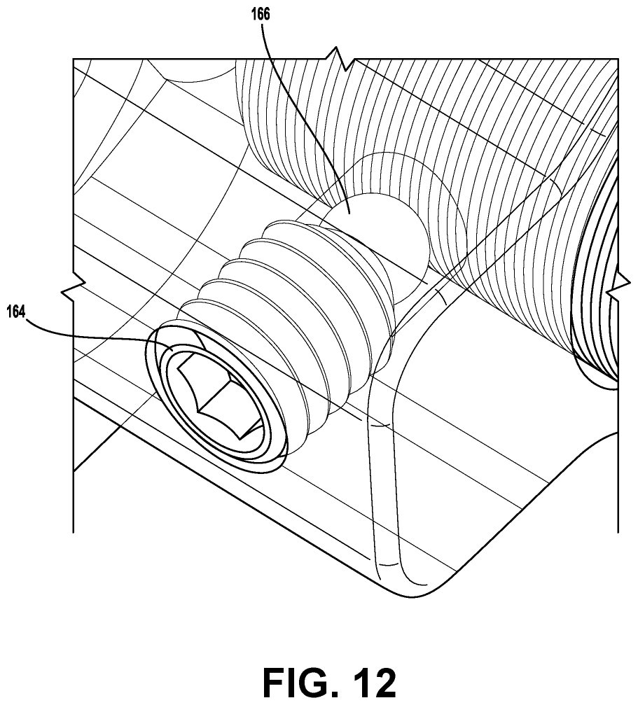

In one example, as shown in FIG. 12, the lower manifold 148 includes a set screw 164 configured to lock a position of the sample injection needle 150 by preventing further rotation of the needle adjustment member 156. When the set screw 164 locks down the needle adjustment member 156, it also locks down the position of the sample injection needle 150. As shown in FIG. 12, in one example the set screw 164 includes a nylon or brass ball 166 configured to directly contact the threads of the needle adjustment member 156 to prevent marring of the threads while preventing further rotation of the needle adjustment member 156. Other soft or rigid set screw mechanisms are possible as well.

In use, the ability to adjust the x, y, and z-positions of the first end 152 of the sample injection needle 150 may be useful in the flow cytometry system 100 described above. In particular, the x-y positioning of the sample injection needle 150 helps to ensure that the plurality of samples 111 enter a center of the fluidic pathway 104 through the flow cell 102, which ensures that the two or more lasers 108A-108D illuminate the samples in such a way that the two or more side scatter detection modules 110A-110D can detect the plurality of samples 111. The z-positioning of the sample injection needle 150 helps to ensure laminar flow through the flow cell 102, which is important for the separation gas-separated fluid flow stream of the flow cytometry system 100. If the z-position of the sample injection needle 150 is incorrect, air may be caught in the sample injection needle 150 or be caught by the inner wall surface of chamber surrounding the sample injection needle 150 and create a position change of the sample within the fluidic pathway 104, thereby causing misalignment of samples through the flow cell 102. Since the flow cytometry system 100 intentionally introduces a separation gas between samples, ensuring laminar via by adjusting the z-position of the sample injection needle 150 is useful. In one example, the data 122 from the control system 118 may be used to determine whether an x-y adjustment or a z-adjustment of the sample injection needle 150 is needed.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and examples have been disclosed herein, other aspects and examples will be apparent to those skilled in the art. The various aspects and examples disclosed herein are for purposes of illustration and are not intended to be limiting, with the true scope being indicated by the following claims, along with the full scope of equivalents to which such claims are entitled. It is also to be understood that the terminology used herein is for the purpose of describing particular examples only, and is not intended to be limiting.

1. A flow cytometry system comprising:
a flow cell;
a fluidic pathway in fluid communication with the flow cell;
a probe in fluid communication with the fluidic pathway, wherein the probe is configured to input a plurality of samples and aliquots of a separation gas between successive ones of the plurality of samples into the fluidic pathway;
two or more lasers positioned such that an illumination spot of each of the two or more lasers is directly on the flow cell;
two or more side scatter detection modules in communication with the two or more lasers;
a processor in communication with the two or more side scatter detection modules; and
a non-transitory computer readable medium having stored therein instructions that are executable to cause the processor to perform functions when using the flow cytometer system, including:
detecting, via a first side scatter detection module of the two or more side scatter detection modules, a first sample of the plurality of samples in the fluidic pathway at a first timestamp;
detecting, via a second side scatter detection module of the two or more side scatter detection modules, the first sample of the plurality of samples in the fluidic pathway at a second timestamp after the first timestamp; and
determining a time delta between a first laser of the two or more lasers and a second laser of the two or more lasers based on a difference between a plurality of first timestamps and a plurality of second timestamps.

2. The flow cytometry system of claim 1, wherein a number of the two or more lasers is equal to a number of the two or more side scatter detection modules.

3. The flow cytometry system of claim 2, wherein the number of the two or more lasers and the number of the two or more side scatter detection modules comprises two, three, four, or five.

4. The flow cytometry system of claim 1, wherein the time delta is determined based on a standard deviation of the difference between the plurality of first timestamps and the plurality of second timestamps.

5. The flow cytometry system of claim 1, wherein the time delta is determined based on a mean of the difference between the plurality of first timestamps and the plurality of second timestamps.

6. The flow cytometry system of claim 1, wherein a fiber optic cable, collecting a scatter light signal from the flow cell illuminated by a given laser of the two of more lasers, connects with a given side scatter detection module of the two or more side scatter detection modules.

7. The flow cytometry system of claim 1, further comprising:
a plurality of photomultiplier detectors, a plurality of photodiode detectors, a filter, an analog-to-digital converter, and a field-programmable gate array.

8. The flow cytometry system of claim 7, wherein the filter comprises one or more of a bandpass filter, a longpass filter, and a dichroic filter.

9. The flow cytometry system of claim 7, wherein the plurality of photomultiplier detectors and the plurality of photodiode detectors comprises one of (i) eight photomultiplier detectors and three photodiode detectors, (ii) sixteen photomultiplier detectors and 4 photodiode detectors, or (iii) twenty-two photomultiplier detectors and five photodiode detectors.

10. The flow cytometry system of claim 1, wherein the time delta ranges from about 50 μs to about 200 μs between any two adjacent lasers of the two or more lasers.

11. The flow cytometry system of claim 1, wherein the first laser is configured to illuminate only light having a red wavelength, and wherein the second laser is configured to illuminate only light having a blue wavelength.

12. The flow cytometry system of claim 11, wherein the non-transitory computer readable medium causes the processor to further perform functions including:
detecting, via a third side scatter detection module of the two or more side scatter detection modules, the first sample of the plurality of samples in the fluidic pathway at a third timestamp after the first timestamp; and
determining a second time delta between the first laser of the two or more lasers and a third laser of the two or more lasers based on a difference between a plurality of first timestamps and a plurality of third timestamps.

13. The flow cytometry system of claim 12, wherein the third laser is configured to illuminate only light having a violet wavelength.

14. The flow cytometry system of claim 12, wherein the non-transitory computer readable medium causes the processor to further perform functions including:
detecting, via a fourth side scatter detection module of the two or more side scatter detection modules, the first sample of the plurality of samples in the fluidic pathway at a fourth timestamp after the first timestamp; and
determining a third time delta between a first laser of the two or more lasers and a fourth laser of the two or more lasers based on a difference between a plurality of first timestamps and a plurality of fourth timestamps.

15. The flow cytometry system of claim 14, wherein the fourth laser is configured to illuminate only light having a yellow wavelength.

16. The flow cytometry system of claim 1, wherein the non-transitory computer readable medium causes the processor to further perform functions including:
correlating, using the time delta, data corresponding to the first sample detected by the first side scatter detection module with data corresponding to the first sample detected by the second side scatter detection module to create a single event data for the first sample.

17. The flow cytometry system of claim 1, wherein the non-transitory computer readable medium causes the processor to further perform functions including:
determining, based on one or more properties of the fluid in the fluidic pathway, a presence of a separation gas in the fluid in the fluidic pathway;
generating separation gas timing data comprising the detected one or more properties of the fluid in the fluidic pathway and a corresponding timestamp; and
identifying a respective sample well of a plurality of sample wells, based, at least in part, on the separation gas timing data.

18. The flow cytometry system of claim 1, wherein the non-transitory computer readable medium causes the processor to further perform functions including:
correlating the first timestamp with the second timestamp to determine a detection event of the first sample of the plurality of samples.

19. The flow cytometry system of claim 18, wherein correlating the first timestamp with the second timestamp comprises:
accumulating data from the first side scatter detection module and the second side scatter detection module for a predefined time interval in separate queues for each side scatter detection module; and
combining data from the first side scatter detection module and the second side scatter detection module if the first timestamp and the second timestamp are within a threshold time difference.

20. A flow cytometry system comprising:
a flow cell;
a fluidic pathway in fluid communication with the flow cell;
a probe having a first end and a second end opposite the first end, wherein the second end of the probe is in fluid communication with the fluidic pathway; and
a collar wash module positioned adjacent the probe, wherein the collar wash module includes a top opening, a bottom opening in fluid communication with the top opening via a common shaft, a first side opening, and a second side opening in fluid communication with the first side opening via the common shaft,
wherein the probe is configured to transition from a first position in which the first end of the probe is positioned outside of the collar wash module to a second position in which the first end of the probe is positioned inside of the collar wash module between the first side opening and the second side opening to a third position in which the first end of the probe is positioned outside of the collar wash module,
wherein a fluid is configured to move between the first side opening and the second side opening when the probe is in the second position to thereby clean the probe,
wherein the first end of the probe is configured to input a plurality of samples into the fluidic pathway from a plurality of sample wells when the probe is in the third position to thereby form a fluid flow stream in the fluidic pathway, and
wherein the first end of the probe is configured to introduce aliquots of a separation gas between successive ones of the plurality of samples in the fluid flow stream to configure the fluid flow stream as a separation gas-separated fluid flow stream.

21. The flow cytometry system of claim 20, wherein the fluid comprises a buffer.

22. The flow cytometry system of claim 20, wherein the fluid comprises a decontamination solution.

23. The flow cytometry system of claim 20, wherein the probe is configured to transition between the second position and the third position between each of the plurality of sample wells.

24. The flow cytometry system of claim 20, further comprising:
a pump configured to pull the fluid through the collar wash module, from the second side opening of the collar wash module, and into a waste container.

25. The flow cytometry system of claim 24, further comprising:
a processor; and
a non-transitory computer readable medium having stored therein instructions that are executable to cause the processor to perform functions when using the flow cytometer system, including:
detecting a clog in the fluidic pathway; and
pumping, via a pump, a fluid through the collar wash module, into the second end of the probe, and into a waste container to remove the clog from the fluidic pathway.

26. The flow cytometry system of claim 25, wherein the clog is detected via one or more bubble sensors positioned on the fluidic pathway.

27. The flow cytometry system of claim 20, further comprising:
a processor; and
a non-transitory computer readable medium having stored therein instructions that are executable to cause the processor to perform functions when using the flow cytometer system, including:
determining, via one or more bubble sensors positioned on the fluidic pathway, a presence of the separation gas in the fluid in the fluidic pathway;
generating separation gas timing data comprising the detected one or more properties of the fluid in the fluidic pathway and a corresponding timestamp; and
identifying a respective sample well of the plurality of sample wells, based, at least in part, on the separation gas timing data.

28. A flow cell module for a flow cytometry apparatus, the flow cell module comprising:
a flow cell;
an upper manifold positioned upstream of the flow cell;
a lower manifold coupled to the upper manifold and moveable in relation to the upper manifold;
a sample injection needle having a first end and a second end opposite the first end;
a needle adjustment member fixedly coupled to the second end of the sample injection needle and moveably positioned in the lower manifold, wherein an interior of a least a portion of the needle adjustment member is threaded such that a rotation of the needle adjustment member adjusts a position of the first end of the sample injection needle with respect to the flow cell; and
a fluidic link connection screw coupled to the needle adjustment member, wherein an interior of the fluidic link connection screw is configured to receive a fluidic pathway.

29. The flow cell module of claim 28, wherein the lower manifold includes a set screw configured to lock a position of the sample injection needle by preventing further rotation of the needle adjustment member.

30. The flow cell module of claim 28, wherein a first end of the flow cell positioned adjacent the first end of the sample injection needle is coned shaped.

31. The flow cell module of claim 28, wherein the lower manifold is moveable in relation to the upper manifold via four adjustment screws configured to move the lower manifold with respect to the upper manifold in an x-y direction.

32. The flow cell module of claim 28, wherein the rotation of the needle adjustment member adjusts the position of the first end of the sample injection needle with respect to the flow cell in a z-direction.

33. The flow cell module of claim 28, wherein the lower manifold includes an input port for a sheath line.

34. The flow cell module of claim 28, wherein the upper manifold, the lower manifold, and the sample injection needle each comprise stainless steel.

35. The flow cell module of claim 28, wherein the sample injection needle comprises a one-piece design.

36. A system comprising:
the flow cytometry system of claim 1;
the flow cytometry system of claim 20; and
the flow cell module of claim 28.
